(19) United States
(12) Patent Application Publication
(10) Pub. No.: US 2009/0123631 A1
(43) Pub. Date: May 14, 2009

(54) Blueberry tea beverage and its preparing process

(76) Inventor: Sen Huang, Jilin (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/916,510

(22) PCT Filed: Jun. 10, 2005
(86) PCT No.: PCT/CN05/00830

§ 371 Date: May 20, 2008

(51) Int. Cl. A23F 3/34; A23L 1/03; A23L 1/238

(52) U.S. Cl. 426/597

(57) ABSTRACT

The present invention provides for a blueberry tea beverage and its preparing process. It is consisted of following ingredients: blueberry leaf, fruit material suspending agent, and pure water. Its beneficial effects are those: 1. Blueberry leaf contains abundant vitamin C, flavones, SOD, and anthocyanidin, thus it can dissipate fatigue, anti-age, remove free radical in body, and protect the vision, has natural health-care functions. 2. Blueberry leaf contains a number of organic acid, and pH value in solution boiled is between 2.5 and 3.5, thus there needs no adding a number of organic acid again, it has outstanding oral feelings, and low cost. 3. Blueberry leaf boiled solution itself shows natural tangerine, thus it has attracting sensory effect.

### FIELD OF THE INVENTION

The present invention, which belongs to food technology, relates to invention and improvement of a kind of beverage.

### BACKGROUND OF THE INVENTION

In present, tea is a kind of beverage, which is prepared mainly from tea leaves by processing and steeping with hot water. Though tea can refresh spirits and promote digestion, there is no vitamin C, anthocyanidin and superoxide dismutase (SOD) and little organic acid in tea leaves, which can't be regarded as functional beverage. In order to make up the deficiency, some organic acids and vitamins can only be added when tea beverage is produced in quantity.

### BRIEF DESCRIPTION OF THE INVENTION

One of the purposes of the present invention is to provide a blueberry tea beverage with health care function.

Another purpose of the present invention is to provide the preparing process of a blueberry tea beverage with health care function.

Blueberry (English name: Blueberry, Latin name: Vaccinium) is also named bilberry in China.

The components of the beverage according to present invention are as follows: (the portion is calculated by weight)

Blueberry leaf: 1-500

Fruit material suspending agent: 0.2-30

Purified water: 994-100

Another kind of components of the beverage according to present invention are as follows: (the portion is calculated by weight)

Blueberry leaf: 1-500

Fruit material suspending agent: 0.2-30

Stevioside: 0-3

Citric acid: 1.5-15

Sugar: 0-200

Purified water: 994-100

The preferred components of the beverage according to present invention are as follows: (the portion is calculated by weight)

Blueberry leaf: 30

Fruit material suspending agent: 2

Stevioside: 0.05

Citric acid: 1.5

Sugar: 70

Purified water: 896.45

The process of preparing beverage according to present invention consists the following steps:

1. screen fresh blueberry leaves by removing foreign matters and rotten or degenerative parts before getting rid of water content by airing and stir-frying; then put stir-fried blueberry leaves and required amount of water into cooker and boil them for 5-20 min; filter out residue of blueberry leaves and keep blueberry leaf boiled solution for use;

2. add fruit material suspending agent into blueberry leaf boiled solution, mix them even followed by filtering, sterilizing and filling into can;

3. if other adjuvant is needed, mix proportioned adjuvant even in homogenizing machine and add them into blueberry leaf boiled solution followed by mixing, sterilizing and filling into the can.

### BENEFITS OF THE INVENTION

1. Blueberry leaf contains abundant vitamin C, flavone, SOD and anthocyanidin, thus it can dissipate fatigue, anti-age remove free radical in body, and protect the vision, has natural health-care function.

2. Blueberry leaf contains a large quantity of organic acid, and pH value in boiled solution is between 2.5 and 3.5, thus there needs no adding a number of organic acid again, it has outstanding oral feelings, and low cost.

3. Blueberry leaf boiled solution itself shows natural tangerine, thus it has attracting sensory effect.

During the process, airing and stir-frying of blueberry leaves are necessary.

### DETAILED DESCRIPTION OF THE EMBODIMENTS

### Embodiment 1

Screen fresh blueberry leaves by removing foreign matters and rotten or degenerative parts; put 30 Kg of selected blueberry leaves into airing oven for airing and stir-frying to remove water content. Then put stir-fried blueberry leaf and 900 Kg of water into cooker and boil them for 15 min. Filter out residue of blueberry leaves and keep blueberry leaf boiled solution for use.

The blueberry leaf boiled solution was added with 2 Kg of fruit material suspending agent, then being mixed, filtered, sterilized and filed into the can.

### Embodiment 2

Screen fresh blueberry leaves by removing foreign matters and rotten or degenerative parts; put 30 Kg of selected blueberry leaves into airing oven for airing and stir-frying to remove water content. Then put stir-fried blueberry leaves and 900 Kg of water into cooker and boil them for 15 min. Filter out residue of blueberry leaves and keep blueberry leaf boiled solution for use.

Put 0.05 Kg of stevioside, 1.5 Kg of citric acid, 70 Kg of sucrose, 2 Kg of fruit material suspending agent and purified water into homogenizing machine and then mix them. The blueberry leaf boiled solution was added with the aforesaid mixture and then added with purified water to make total weight of the blueberry tea beverage achieve 1000 Kg. Then the beverage was evenly mixed, filtered, sterilized and filed in to the can.

1. A Blueberry tea beverage is made up with: (the portion is calculated as weight)
Blueberry leaf: 1-500
Fruit material suspending agent: 0.2-30
Purified water: 994-100

2. The Blueberry tea beverage as described in claim 1, wherein the portions of each component are within the following scope: (the portion is calculated as weight)
Blueberry leaf: 1-500
Fruit material suspending agent: 0.2-30
Stevioside: 0-3
Citric acid: 1.5-15
Sugar: 0-200
Purified water: 994-100

3. The Blueberry tea beverage as described in claim 1, wherein the preferred portion of each component are as follows: (the portion is calculated as weight)
Blueberry leaf: 30
Fruit material suspending agent: 2
Stevioside: 0.05
Citric acid: 1.5
Sugar: 70
Purified water: 896.45

4. A process for preparing the blueberry tea beverage as described in claim 1 includes the following steps:
a. screen fresh blueberry leaves by removing foreign matters and rotten or degenerative parts before getting rid of water content by airing and stir-frying; then put stir-fried blueberry leaves and required amount of water into cooker and boil them for 5-20 min; filter out residue of blueberry leaves and keep blueberry leaf boiled solution for use.
b. add fruit material suspending agent into blueberry leaf boiled solution, mix them even followed by filtering, sterilizing and filling into can.
c. if other adjuvant is needed, mix proportioned adjuvant even in homogenizing machine and add them into blueberry leaf boiled solution followed by mixing, sterilizing and filling into the can.

5. The process for preparing the blueberry tea beverage as described in claim 4, wherein the step of airing and stir-frying of blueberry leaves is necessary.
